(19) United States
(12) Patent Application Publication
(10) Pub. No.: US 2009/0083820 A1
(43) Pub. Date: Mar. 26, 2009

(54) RE-TRANSMISSION OF TELEVISION CHANNELS OVER NETWORK

(75) Inventors: Derek T. Harrar, Rydal, PA (US); Andrew I. Rosenburg, Weston, CT (US); Gerard J. Lewis, JR., Wynnewood, PA (US); Richard C. Gasloli, Downington, PA (US)

Correspondence Address: BROOKS KUSHMAN P.C., 1000 TOWN CENTER, TWENTY-SECOND FLOOR, SOUTHFIELD, MI, 48075, US

(73) Assignee: COMCAST CABLE HOLDINGS, LLC, Philadelphia, PA (US)

(21) Appl. No.: 11/860,812

(22) Filed: Sep. 25, 2007

(51) Int. Cl. H04N 7/173; H04N 7/16

(52) U.S. Cl. 725/127; 725/9

(57) ABSTRACT

A method and system for re-transmitting television signals or other signals over a network. The re-transmission optionally being selected on dynamic basis according to demand for particular signals, wherein the re-transmitted signal may be changed as the demand for particular signals change. The signal demand may be determined from votes or other measures of subscriber inputs/desires.

### BACKGROUND OF THE INVENTION

1. Field of the Invention

The present invention relates to re-transmission of television signals over a network.

2. Background Art

Television service providers are able to broadcast any number of television channels over wireline or wireless communication mediums. Some television service providers are able to broadcast 50, 100, or more television channels. A full compliment of television channels can be defined as any number of television channels available to a particular subscriber.

In some environments, such as at college universities or other locales where a number of users may be associated with a common network, typically a private network, the university (subscriber) may desire to distribute or re-transmit the television channels over a local area network (LAN) for viewing by students or users associated with the network. The LAN may have bandwidth, processing, or other restrictions that prevent it from distributing the full compliment of television channels and/or the associated entity may only pay for re-transmitting a selected number of channels, i.e., it may be limited to supporting re-transmission of some number of channels less than the full compliment.

One issue faced by the subscriber relates to selecting which of the full compliment of channels to re-transmit over the LAN. Accordingly, a need exists to facilitate selecting a portion of the television channels available from the full compliment of television channels for further distribution according to the limitations of the LAN.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for supporting re-transmission of television channels in accordance with one non-limiting aspect of the present invention; and

FIG. 2 illustrates a webpage associated with a voting forum in accordance with one non-limiting aspect of the present invention.

### DETAILED DESCRIPTION OF THE PREFERRED EMBODIMENT(S)

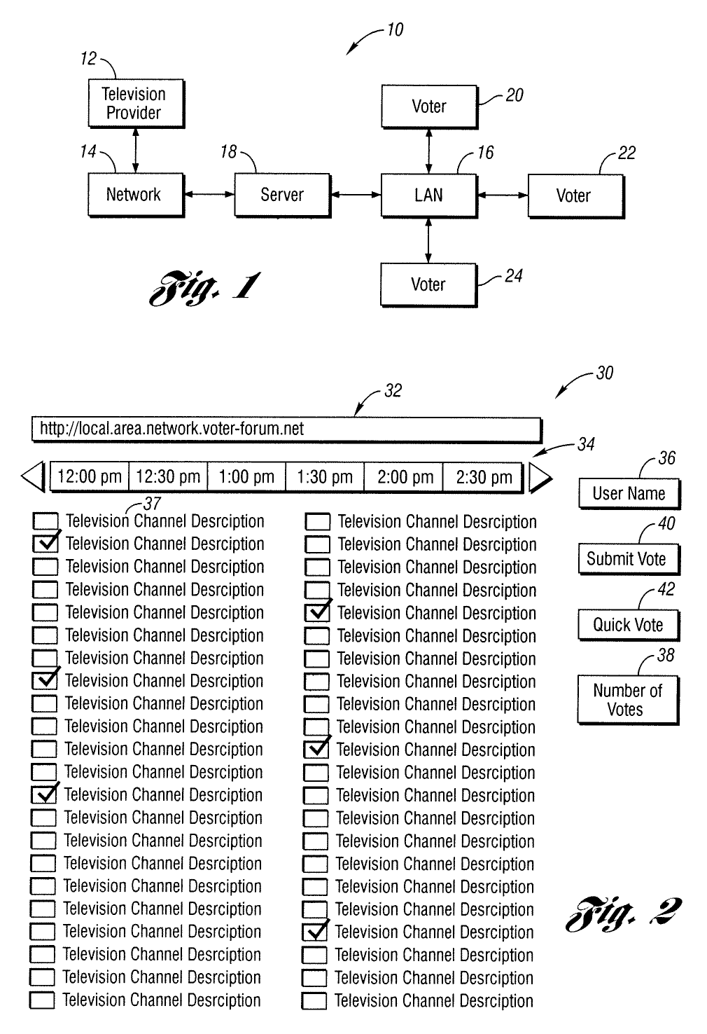

FIG. 1 illustrates a system 10 for supporting re-transmission of television channels in accordance with one non-limiting aspect of the present invention. The system 10 relates to facilitating re-transmission of television channels provided from a television service provider 12. The television service provider 12 may be a broadcast, cable, satellite, or other television service provider having capabilities for transmitting television channels. The present invention is described with respect to re-transmitting television channels for exemplary purposes. The present invention fully contemplates re-transmitting other signals besides television channels, including other electronic forms of data that may be transmitted in separate channels, streams, or other mediums.

A network 14 may be included to facilitate transmitting the television signals from the television service provider 12. The network 14 may be a wireline and/or wireless communication medium having capabilities to support signal transmission according to any type of transmission protocol. The network 14 may be used to transmit the television signals to any number of subscribers (not shown). One of the subscribers may be a university or other entity having a local area network (LAN) 16 for supporting electronic communications with a number of users, referred to as voters 20-24 in FIG. 1. The university may include a television server 18 to facilitate receiving the television signals from the network 14.

The television server 18 may be configured to facilitate re-transmitting the television signals over the LAN 16. The television service provider 12 may broadcast a plurality of television channels, for example 50. A full compliment of television channels can be defined as all of television channels available to the university which, for exemplary purposes of the present invention, has been selected to be 50 television channels.

The LAN 16 may have bandwidth, processing, or other restrictions that prevent it from supporting re-transmission of the full compliment of television channels and/or the university may only pay for re-transmission of a limited number of the television channels. The present invention contemplates a solution whereby a subset of the full compliment of channels may be selected for re-transmission over the LAN 16. The television server 18 may be configured or instructed to facilitate such selection and re-transmission of the television channels. This may include the television server 18 being configured or instructed to facilitate selecting and re-transmitting the subset of channels, for example, 10 channels.

The television signals may be broadcast from the television provider 12 with any type of format. The present invention contemplates at least one arrangement where the television service provider 12 broadcasts television signals in an analog format. The television server 18 may be configured to receive the analog signals and to convert the signals, at least the signals corresponding with the television channels selected for re-transmission, to a digital format, such as an IP format suitable for multicast transmission over the network 14.

FIG. 2 illustrates a webpage 30 associated with a voting forum in accordance with one non-limiting aspect of the present invention. The voting forum may be hosted by the server 18 and located at a particular URL 32. The voting forum may be used to facilitate selecting the subset of television channels for re-transmission over the LAN 16. Those entitled to access the television channels carried over the LAN 16, referred to in FIG. 1 as the voters 20-24, may be entitled to cast votes through the webpage 30 to facilitate identifying the channels they may desire for re-transmission. The television server 18 or other element may tabulate and otherwise track the votes for use in selecting the channels for re-transmission.

One channel selection methodology may include selecting the most popular or highly demanded channels for re-transmission. This may include identifying the maximum number of channels the LAN 16 can support, and/or that have been purchased, and selecting the corresponding number of television channels for re-transmission. The maximum number channels that the LAN 16 can support may increase and/or decrease depending on purchasing changes and/or LAN bandwidth availability. For example, if more/less bandwidth is consumed during certain periods of the day or as processing demands dynamically change according to user consumption, more/less channels may be available during those periods. Rules and other parameters may also be used to establish the number of channels, including limiting LAN data transmission capabilities during peak television viewing times so that more channels can be re-transmitted and/or limiting the number of re-transmitted channels during peak data transmission times so that more data can be transmitted.

The most popular channels may be periodically updated and changed throughout the day, on a weekly or monthly basis, or according to any other schedule. The webpage 30 may include a time selection menu 34 to facilitate scrolling through a half-hour based voting schedule where votes may be cast for different channels at half-hour intervals. Of course, other time intervals are also contemplated. The voters 20-24 may access and be authenticated to vote by inputting their user name in a user name field 36. Votes for particular television channels may be cast by checking a box next a channels description 37 provided next to each channel listing. A number of votes display 38 may indicate the number of channels to vote for during the selected time slot, which can increase/decrease as described above. Once at least one vote is cast the votes may be submitted with selection of a submit vote button 40. The voters 20-24 may be required to enter a minimum or maximum number of votes.

Optionally, a quick vote button 42 may be included to facilitate voting on a more universal basis so that the voter is not required to enter votes for each voting period. The quick vote can be used to cast votes for the entire day, or other interval of time, so that the television channels having checks are automatically selected for all voting intervals subject to the quick vote. If the quick vote is associated with a full day of voting and the votes are tabulated every half-hour, the quick vote can enter the same votes for each half-hour tabulating period throughout the day.

Each of the television channel descriptions 37 shown in the webpage 30 may be highlighted or selected to display additional information. The additional information may provide a synopsis of the television channel and the content it typically shows. The additional information may also include a description of the program showing for the selected period of time. This can be helpful to facilitate voting on a program-by-program basis where voters 20-24 may locate programs of particular interest and vote for them.

The webpage 30 can allow voters 20-24 to cast votes for upcoming time periods and/or to make a “favorites” votes where particular channels or programs may be automatically selected according to a predefined schedule set by each voter 20-24. The voters 20-24 can set-up and schedule votes to occur for particular channels and/or programs throughout the day so that they can cast and change their votes without having to repeatedly access the voting forum.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of distributing television channels over a local area network (LAN), the method comprising:
tabulating votes casts in support of distributing particular television channels included within a full compliment of television channels; and
distributing a subset of the full compliment of television channels over the LAN based on highest vote count.

2. The method of claim 1 further comprising changing at least one of the distributed channels to correspond with another more popular channel determined after re-tabulating votes cast at a subsequent period of time.

3. The method of claim 1 further comprising providing a voting forum to facilitate casting votes for particular television channels.

4. The method of claim 3 further comprising limiting access to the voting forum to a number of voters previously associated with the LAN and authorized to view the television channels distributed over the LAN.

5. The method of claim 1 further comprising transmitting the full compliment of television channels from the television service provider to a television server associated with the LAN, the television server configured to select the most popular television channels from the full compliment of television channels for distribution over the LAN.

6. The method of claim 5 further comprising transmitting the full compliment of televisions channels to the television server in an analog format, the television server converting the most popular television channels to a digital format for distribution over the LAN.

7. The method of claim 5 further comprising the television server automatically selecting the most popular television channels based on information received through the voting forum.

8. The method of claim 1 further comprising setting the maximum number of channels to be distributed based on available LAN bandwidth.

9. The method of claim 8 further comprising increasing or decreasing the maximum number of channels distributed over the LAN based on changes in bandwidth availability.

10. A method of re-transmitting television channels over a local area network (LAN) having insufficient bandwidth to carry a full compliment of television channels available from a television service provider, the method comprising:
determining available LAN bandwidth;
determining a maximum number of televisions channels for distribution over the LAN based on the available LAN bandwidth; and
distributing a subset of the full compliment of television channels deemed to be the most popular over the LAN.

11. The method of claim 10 further comprising continuously determining the most popular channels as a function of votes cast in support of particular channels.

12. The method of claim 11 further comprising changing at least one of the distributed channels to correspond with another more popular channel determined from votes cast at a subsequent period of time.

13. The method of claim 10 further comprising providing a voting forum to facilitating casting votes for particular television channels.

14. The method of claim 13 further comprising configuring the voting forum to facilitate voting for channels on a periodic basis and determining the most popular channels at an interval corresponding with the periodic basis.

15. The method of claim 13 further comprising configuring the voting forum to facilitate automatically voting for channels on a repeating basis.

16. The method of claim 13 further comprising configuring the voting forum to provide a program description for use in describing programs showing on each channel for a particular time of day.

17. A television server configured for re-transmitting television channels received from a television service provider over a local area network (LAN), the server configured for:
determining a maximum number of television channels supportable by the LAN, the maximum number of television channels being less than a full compliment of television channels available from the television service provider; and
re-transmitting the maximum number of television channels deemed to be the most popular over the LAN.

18. The server of claim 17 further configured for hosting a voting forum through which votes are received for use in determining the most popular television channels.

19. The server of claim 17 further configured for re-transmitting the television channels in IP multicast streams.

20. The server of claim 17 further configured for changing at least one of the re-transmitted channels to correspond with another more popular channel determined from votes cast at a subsequent period of time.
